(19) United States
(12) Patent Application Publication
(10) Pub. No.: US 2011/0116212 A1
(43) Pub. Date: May 19, 2011

(54) Method of Recovering Power Losses In A Residential, Commercial, or Industrial Facility

(76) Inventors: Timothy A. Rosemore, Reno, NV (US); James Owings, Dahlonega, GA (US); Shawn Ferrell, Brighton, MI (US)

(21) Appl. No.: 12/915,442

(22) Filed: Oct. 29, 2010

Related U.S. Application Data
(60) Provisional application No. 61/256,064, filed on Oct. 29, 2009.
(60) Provisional application No. 61/256,068, filed on Oct. 29, 2009.

(51) Int. Cl. H02B 1/00

(52) U.S. Cl. 361/623

(57) ABSTRACT

Disclosed is a method of installing a passive electrical element, or voltage control guard (VCG), in an electrical circuit of a circuit breaker box in an electrical network of a residential, industrial, or commercial facility. The VCG has an inherent capacitance, resistance, and inductance and has at least two electrical leads that are installed to establish a parallel connection on a neutral bus bar in the circuit breaker box, with a portion of a current on neutral bus bar flowing through the VCG. When the VCG is properly installed, the VCG converts wasted or lost power in the electrical network to useable power, thereby reducing the total electrical consumption of the facility.

### CROSS REFERENCE TO RELATED APPLICATIONS

This application claims the benefit of U.S. Provisional Application No. 61/256,064 filed Oct. 29, 2009 and the benefit of U.S. Provisional Application No. 61/256,068 filed Oct. 29, 2009.

### INCORPORATION BY REFERENCE

U.S. Provisional Patent Application No. 61/256,064 filed Oct. 29, 2009, and U.S. Provisional Patent Application No. 61/256,068 filed Oct. 29, 2009, are hereby incorporated by reference for all purposes as if presented herein in their entirety.

### FIELD OF THE DISCLOSURE

The present disclosure relates to electrical power systems and, more specifically, to a method for providing a smoothing or reducing of electrical instabilities and/or electrical noise in an electrical current in a typical electrical network or circuit, such as a residential electrical network, and recovering unused or wasted power by converting the electrical instabilities and electrical noise to usable power.

### BACKGROUND OF THE DISCLOSURE

Well established power distribution systems exist throughout most of the United States, and other countries, which provide alternating current (AC) power to customers via transmission lines. Common residential electrical power service in the United States consists of a three-wire AC system supplied by the local power company. The three wires originate from transmission lines supported by a utility and consist of a neutral wire, which is connected to earth and a center tap of a pole transformer, and two “hot” wires. The power in each of the hot wires supplies either 120 volts (V) or 240 V to the residential circuits and the voltage in each of the two wires is 180 degrees out of phase with each other, which enables the voltage to be supplied at either 120V or 240V. In addition to the voltage, the power is also transmitted at a particular current. The voltage and current are sinusoidal and can be represented graphically by sine waves of differing amplitudes. Ideally, the current sine wave and the voltage sine wave are in phase with each other. The power supplied is used to operate a variety of electrical equipment typically found within a household ranging from electrical appliances to smaller components such as, for example, a hairdryer or ceiling fan.

Due to the nature of the electrical equipment being powered, losses occur because of inefficiencies associated with the equipment. There are a variety of losses associated with the equipment, such as thermal losses, resistance losses, and internal losses. However, there are also losses that arise when the current and voltage are no longer in phase. The type of equipment operated can be instrumental in causing a phase shift and result in background electrical “noise” in an electrical circuit. For example, electrical equipment that is largely inductive, such as motors and compressors, will tend to cause the current to lag the voltage and the result is a loss in power.

Reducing power loss has been a focus of much development for some time and energy conservation is becoming a higher priority, as evidenced by the recent developments and advancements of “Green” technologies. In particular, clean and renewable generation systems are being seen as priority. The market of wind sources, solar energy and small hydroelectric power plants is rapidly increasing. One area of energy savings and conservation which may have been overlooked is that of recovering losses within residential, commercial, and industrial electrical networks and converting those loses to usable power.

### BRIEF DESCRIPTION OF THE FIGURES

The present disclosure is now described with respect to the embodiments seen in following drawings. According to common practice, the various features of the drawings discussed below are not necessarily drawn to scale. Dimensions of various features and elements in the drawings may be expanded or reduced to illustrate more clearly the embodiments of the disclosure.

FIG. 1 is a schematic diagram of an exemplary residential electrical connection from an outside power source to a typical circuit breaker and residential electrical network.

FIGS. 2A-2C are plots showing voltage and current as a function of time for a variety of different electrical devices.

FIG. 3 is a plot showing voltage and current out of phase and the power losses that arise from the phase shift.

FIG. 4 is a schematic diagram that illustrates electrical “noise” in the electrical current as a function of cycle.

FIG. 5 is a schematic diagram of a Voltage Control Guard (VCG).

FIG. 6 is a schematic diagram showing the VCG installed in a circuit breaker.

FIGS. 7A-7E show acceptable installation configurations for the VCG.

FIG. 8 shows an alternate installation embodiment of the disclosure.

### DETAILED DESCRIPTION OF THE EMBODIMENTS OF THE DISCLOSURE

The following detailed description of the disclosed embodiments is merely exemplary in nature and is not intended to limit the embodiments or the application and uses of the embodiments. Furthermore, there is no intention to be bound by any theory presented in the preceding background of the invention or the following detailed description of the embodiments. It is to be appreciated that the described embodiment is not limited to use in conjunction with a particular type of power distribution system, or a residential power distribution system. Thus, although the present embodiment is, for convenience of explanation, depicted and described as being implemented in a residential power distribution system, it will be appreciated that it can be implemented in various other types of power distribution systems, various types of current and voltage schemes, such as three phase current and voltage networks typically associated with commercial applications, and in various other systems and environments.

Exemplary embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

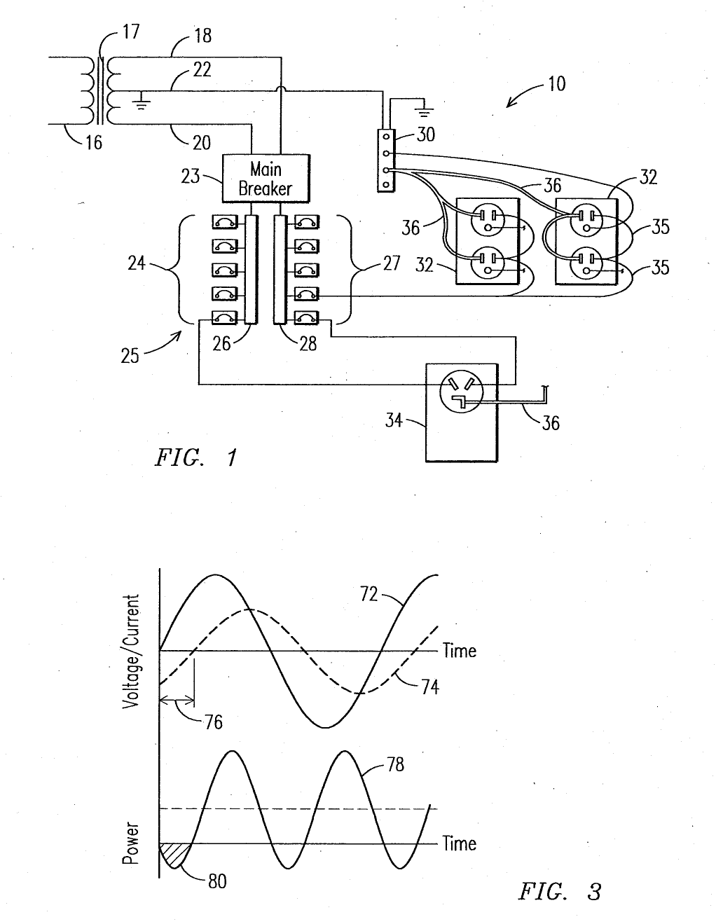

FIG. 1 is a schematic diagram illustrating an example of a residential electrical network 10. Though discussed in context of a typical residential electrical network, it is understood that this disclosure is equally applicable to commercial and industrial electrical networks, or any electrical network. Outside electrical power service is provided to the electrical network by way of three conductors 18, 20, 22, which are connected to a remote power source 16 by way of a transformer 17, which steps the voltage up or down. The outside electrical power source is generally understood to be the electric grid, ultimately reaching the residential electrical network from an industrial power plant, through a series of switching stations, transformers, and power transmission lines. These conductors 18, 20, 22 are appropriately insulated and may be fed to the top end of a circuit breaker box 25 through a conduit (not shown). One example of a circuit breaker box 25 comprises a sheet metal shell (not shown) having a back panel and rectangular side panels defining an area within which circuit breakers 23 and the electrical connections are mounted thereto.

Typically, in the United States, for example, the conductors 18, 20 are connected across an alternating current source having a potential of 240 volts (V) or 120 V, and 60 Hz. This method is also applicable to other electrical markets, for example, the 110 V and 50 Hz electrical market. The third conductor, 22 is a neutral conductor and functions to complete an electrical circuit, between the conductors 18, 20 and the neutral conductor 22. For a residential application, the potential of the conductors 18, 20 with respect to the neutral conductor 22 is, for example, 120 V, but may be as much as 480 V, with the potential of the conductors 18, 20 being 180 degrees out of phase. The conductors 18, 20 are, respectively, connected to “main” circuit breakers 24, 27. The conductor 22 (also referred to herein as the “neutral lead” 22) is connected to a neutral bus bar 30, which is, preferably, grounded.

According to the exemplary embodiment of FIG. 1, electrical power 16 is delivered to the residential circuit breaker 25, which is arranged within a facility to provide electricity to power electrical equipment. The two conductors 18, 20 are connected to a main breaker 23. The main breaker 23 has two branches 26, 28 of circuit breakers 24, 27, respectively, and the circuit breakers 24, 27 are grouped together. The circuit breakers 24, 27 are a safety feature protecting electrical equipment from electrical surges in the conductors 18, 20. Extending from the circuit breakers 24, 27, are a plurality of electrical leads 35 that are connected to electrical sockets 32, 34 throughout the facility. Additionally, a ground wire 36 is also connected to each electrical socket 32, 34, completing the electrical circuit. The electrical socket 32, 34 is the location where electrical equipment is attached via, for example, an electrical plug, and receives electricity to power the equipment.

Electrical “noise” is developed in the electrical network. Electrical “noise” will be understood by the person of ordinary skill in the art to mean any electrical signal, or portion of an electrical signal, that may be out of phase and/or not equivalent to a fundamental signal, e.g. 110 V at 50 Hz or 120V at 60 Hz. The electrical “noise,” which appears in the waveform of the electrical current can be identified in the neutral lead 22 or the neutral bus bar 30. Generally, differential current signals contain all non-common mode noise present in the system. The general assumption is the neutral current is wattless, or contains no power. However, neutral current is only wattless if it is at zero voltage with correct phase. This is rarely the case for the neutral lead 22.

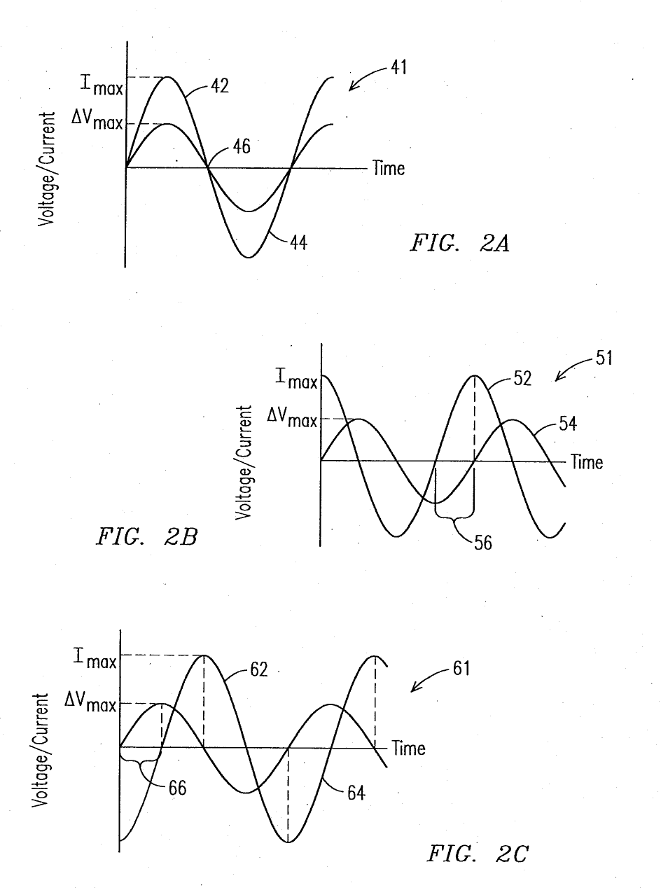

A more detailed discussion of electrical “noise” in the electrical current and the importance of the “noise” is helpful in understanding the disclosure. Turning now to FIGS. 2A-2C, typical voltage/current curves are illustrated for different electrical elements, where voltage and current are displayed as a function of time. FIG. 2A shows the relationship between current 42 and voltage 44 for a circuit that is primarily a resistive circuit, comprised of purely resistive elements. As can be seen in the plot 41, the current 42 and the voltage 44 are “in phase.” This is generally understood to mean that the current 42 and voltage 44 are both increasing and decreasing during the same time periods, and have the same wavelength; and the current 42 and the voltage 44 cross from positive to negative at the same time, which is the time represented by location 46. Resistive elements include, but are not limited to, elements such as light bulbs, toasters, and toaster ovens.

FIG. 2B shows the relationship between current 52 and voltage 54 for a circuit that is primarily a capacitive circuit, comprised of purely capacitive elements. In this type of circuit, the current 52 generally leads the voltage 54. The amount the current 52 leads the voltage 54 gives rise to the phase shift, and is identified as location 56.

FIG. 2C shows the relationship between current 62 and voltage 64 for a circuit that is primarily an inductive circuit, comprised of purely inductive elements. In this type of circuit, the current 62 generally lags the voltage 64. The amount the current 62 lags the voltage 64 also gives rise to a phase shift, and is identified as location 66. Inductive elements include, but are not limited to, elements such as motors and compressors.

The current and voltage out of phase will lead to losses. This can be seen in FIG. 3. FIG. 3 is a plot of voltage 72 and current 74, with the voltage 72 and current 74 out of phase by an amount 76. Below the voltage/current plot is a plot which shows the accompanying power 78. There is a power loss 80 associated with the phase shift 76 and this is the power loss that is desired to be recovered.

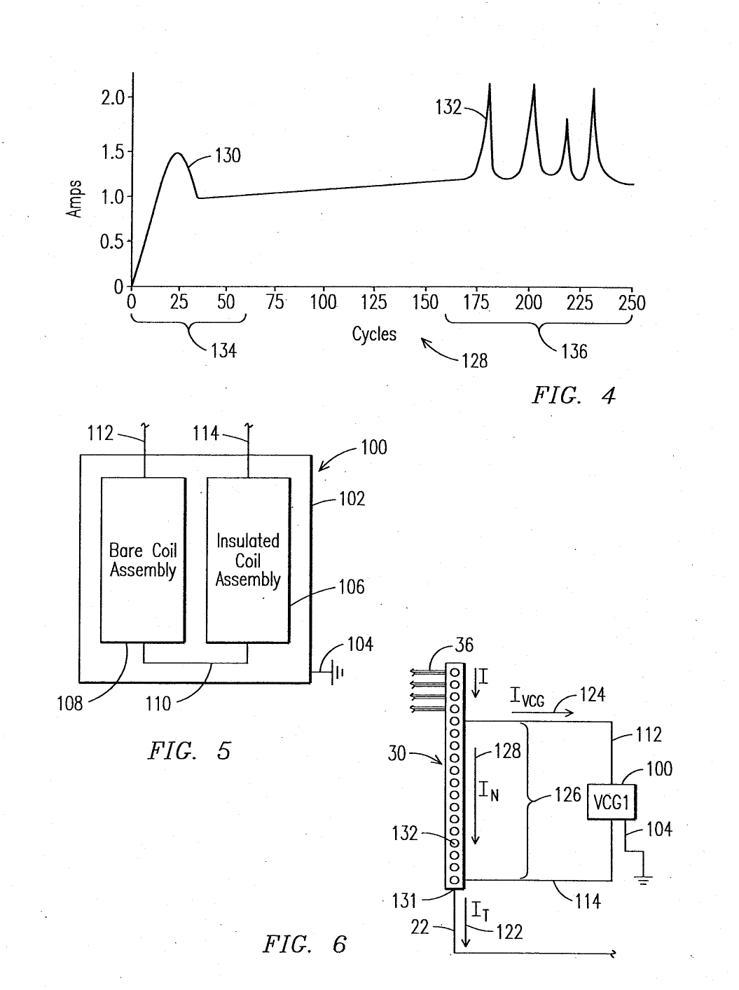

Turning now to FIG. 4, an alternate representation of electrical “noise,” or losses in an electrical element is provided. FIG. 4 is a plot 128 of the current 130 that flows through a typical motor during startup and operation. During startup 134, which is represented approximately by cycles 1-60, the current 132 increases from zero to a peak of about 125 Amps, and then reduces before increasing to a steady state condition 136, which is represented approximately by cycles 160-249. Electrical noise 132 can be seen as spiking of the current, and this spiking leads to electrical losses.

A passive electrical element, often referred to herein as a voltage control guard (VCG) is utilized in the processes of the present disclosure. One example of a VCG that may be used in connection with the present disclosure is that disclosed in U.S. patent application Ser. No. 12/504,763, filed Jul. 17, 2009. The disclosure of U.S. patent application Ser. No. 12/504,763 is incorporated herein in its entirety by this reference. An example VCG 100 is illustrated in FIG. 5. The VCG 100 includes an outer enclosure 102 and internal to the enclosure 102 are a plurality of coil assemblies 106, 108. Each coil assembly 106, 108 has a specified inductance, capacitance, and resistance and the coil assemblies 106, 108 are connected in series by connecting element 110. One coil assembly is a bare coil assembly 108 and the other is an insulated coil assembly 106 and the VCG 100 requires a minimum of one insulated coil assembly 106 and one bare coil assembly 108. Two connections, neutral connection A 112 and neutral connection B 114, are connected to the neutral bus bar 30 (see FIG. 1 item 30). An alternate embodiment that will be discussed includes a third neutral connection (not shown). In exemplary embodiments, the VCG 100 provides shielding for the internal components and grounding by appropriate techniques that will be understood by those skilled in the art. By way of example, but not limitation, according to some embodiments: the outer enclosure may be grounded via a connection 104; the outer enclosure may be metallic or appropriately lined and act as a faraday cage, shielding the inner portion of the enclosure from external static electric fields.

In theory, the VCG 100 takes energy from the electrical “noise” in the electrical current and converts it to useful power. Energy is taken from frequencies outside the fundamental 60 Hz range and is returned in the fundamental 60 Hz range. The VCG is pseudo-inductive, and a fundamental concept pertaining to inductors is that an inductor can change “current energy” into “voltage energy.” Accordingly, when the current changes in an inductor, a voltage is created across the inductor. The VCG is effective on neutral currents that contain electrical “noise.” Electrical elements such as lighting, computers, blowers, and appliances, for example, all operate to create electrical “noise” on the neutral leads of the electrical network.

Installation of the VCG in an electrical network in accordance with methods and principles of the present disclosure is critical for reliable operation. The VCG is typically installed in the residential circuit breaker box (25 in FIG. 1). However, the VCG may be installed in any electrical network or circuit where the reduction of electrical “noise” and/or the conversion of electrical “noise” to useful power is desired. FIG. 6 is an enlarged schematic diagram of the residential network 10 of FIG. 1. A neutral bus bar 30 is arranged within the circuit breaker box (not shown). The neutral bus bar 30 is generally a solid bar capable of conducting electricity and has a plurality of locations 132 to receive neutrals and grounds (collectively illustrated as 120) from various electrical circuits throughout the facility. The ground wires 36 are preferably bunched together and not spaced out along the neutral bus bar 30. FIG. 6. illustrates the VCG 100 in one of several acceptable installation configurations of the present disclosure. An aspect of the installation process of the present disclosure is to install the VCG 100 so the current entering the neutral bus bar 30 is split, or divided. Thus, the VCG 100 functions as a current divider, with a portion of a total current 122 (I_{T}, as defined below) flowing through the VCG 100, illustrated as 124 (I_{VCG}), and the balance of the current 128 (I_{N}) flowing through the neutral bus bar 30. It is assumed that the current on the neutral bus bar 30 contains some level of noise. The VCG current 124 (I_{VCG}) can be calculated by the following relationship,

I_{VCG}=[(R_{Neutral Path})/(R_{Neutral Path}+R_{VCG Path})]*I_{T}, where

I_{VCG} is the current flowing through the VCG 100,

R_{Neutral Path} is the resistance of the parallel path 126 of the neutral bus bar 30,

R_{VCG1 Path} is the resistance of the VCG, and

I_{T} is the total current as measured at the neutral lead 22.

Thus, the current flowing through the parallel path 126 of the neutral bus bar 30, I_{N}, is the difference between the total current 122 (I_{T}) and VCG current 124 (I_{VCG}). It is preferable that the total current 122 (I_{T}) be divided so at least 3 milliamps (I_{VCG}) per amp of total current (I_{T}) flows over the neutral lead 22 126 flows through the VCG 100. Or, expressed alternatively, the VCG current (I_{VCG}) should be at least 0.3 percent of the total current (I_{T}) flowing through the neutral lead 22. Preferably, I_{VCG} should be at least 5 milliamps per amp of total current I_{T}, or at least 0.5 percent of the total current I_{T} should flow through the VCG 100.

In order for the VCG 100 to function, a minimum activation current is required to flow through the VCG 100. The term minimum activation current as used throughout this disclosure is understood to be the product of the total current (I_{T}) times a minimum activation ratio. The term minimum activation ratio is understood to be a ratio discovered, either empirically or by measurement, that represents, for a particular device, the minimum required activation current per amp of total current (I_{T}). Specific to this disclosure, the minimum activation ratio is at least 3 milliamps per amp of total current I_{T} at the neutral lead 22. The minimum activation current may cause a field to develop within the coil assemblies (see FIG. 5, 106, 108). Since the current is an alternating current, the field may develop and collapse at a rate equal to the fundamental frequency. For example, it the fundamental frequency of the current is 60 Hz, the field may develop and collapse sixty times per second. The developing and collapsing of the field may be associated with the conversion of electrical noise in the current to a useful voltage, or power. However, the developing and collapsing may only occur if the minimum activation current is flowing through the VCG 100. Therefore, for the VCG 100 to work properly, at least the minimum activation current should be flowing through the VCG 100. It is understood that a current greater than the minimum activation current may flow through the VCG 100. There may be a maximum effective value of VCG current 124 (I_{VCG}) flowing through the VCG 100 where the VCG reaches a plateau. Above this maximum effective value of VCG current 124 (I_{VCG}), the VCG 100 may saturate.

The minimum activation current required to ensure the VCG 100 is working properly may vary depending on the configuration of the particular VCG 100 installed. For the embodiments disclosed herein, the minimum activation current is at least 0.3 percent of the total current 122 (I_{T}). It is understood that other VCG configurations may exist with each different configuration having a different minimum activation ratio. The minimum activation ratio may be determined experimentally or analytically.

The VCG may be installed on the neutral bus bar 30 found in electrical service panels of the circuit breaker box. It is counter intuitive and unexpected that mounting the VCG 100 to the neutral bus bar 30 can allow any current 122 to flow through the VCG 100. In some cases, the VCG 100 can be installed to the neutral bus bar 30 without having to exercise a logic process, as described below. However, in most cases the installation methods and logic process of the present disclosure explained below will optimize the ability of the VCG 100 to provide the greatest benefit.

As mentioned, the VCG 100 acts as a current divider. According to the present disclosure, the preferred installation embodiments are so assembled as to generate a VCG-current (I_{VCG}) across the VCG 100. The VCG current 124 (I_{VCG}) is, at least 3 milliamps of current flowing through the VCG per each amp of total current 122 (I_{T}). According to one embodiment, the installation of the VCG 100 as disclosed herein generates at least 5 milliamps of VCG current 124 (I_{VCG}) per each amp of total current (I_{T}) 122.

The logic used to install the VCG in accordance with the present disclosure includes dividing the total current 122 (I_{T}) between the neutral bus bar 30 and the VCG 100 such that the VCG current 124 (I_{VCG}) is at least the minimum activation current of the VCG 100. This can be done by executing one, or any combination, of the following methods. Each of the methods discussed below aim to achieve a specific goal. That goal is to install the VCG 100 such that at least the minimum activation current flows through the VCG 100.

Generally, the VCG 100 will be installed using the following method. First, the minimum activation ratio for the VCG 100 must be determined. As discussed, the minimum activation ratio may be determined either experimentally or analytically. Typically, the VCG 100 may be installed on the neutral bus bar 30. Prior to installing or connecting the VCG 100 to the neutral bus bar 30, the total current 122 (I_{T}) at the neutral lead 22 may be measured. The total current (I_{T}) 122 is initially measured to verify that a sufficient amount (e.g. at least 1 amp) of total current 122 (I_{T}) is flowing on the neutral lead 22, such that when the total current (I_{T}) 122 is divided, the minimum activation current will flow to the VCG 100. Any means of measuring the total current (I_{T}) 122 may be used. The VCG leads 112, 114 (see FIG. 5) are connected to the neutral bus bar 30, thus connecting the VCG 100 to the neutral bus bar 30. It is preferred that one of the two VCG leads 112, 114 be connected to the neutral lead 22 at a knuckle 131. The remaining VCG lead 114, 112 may be connected to the neutral bus bar 30 so that the total current (I_{T}) 122 is divided into a portion of the current 124 (I_{VCG}) flowing through the VCG 100 and a portion of the current (I_{N}) 128 flowing in the parallel path 126 of the neutral bus bar 30. The current (I_{VCG}) 124 flowing through the VCG 100 may be measured to verify that at least the minimum activation current is flowing through the VCG 100. If the current (I_{VCG}) flowing through the VCG is not at least the minimum activation current, then the connection of the VCG 100 to the neutral bus bar 30 is adjusted, and/or one of the other methods discussed below is used, so at least the minimum activation current flows through the VCG 100. The methods below of ensuring that at least the minimum activation current flows through the VCG 100 essentially involve adjusting the resistance of the VCG 100 and/or the resistance of the parallel path 126 until the minimum activation current flows through the VCG 100. Therefore, the methods disclosed herein are at least directed toward establishing a resistance ratio (i.e. the resistance of the parallel path 126 divided by the sum of the resistance of the VCG 100 plus the resistance of the parallel path 126) so the minimum activation current flows through the VCG 100

A first method of adjusting the resistance ratio may involve reducing the overall resistance of the VCG path. The VCG 100 has its own inherent resistance (R_{VCG1 Path}) that is established by the VCG leads 112, 114, the coil assemblies 106, 108 and the connecting element 110. Thus, one way to reduce the resistance of the VCG path is to reduce the length of the VCG lead wires 112, 114, thereby reducing the resistance of the VCG 100.

A second method of adjusting the resistance ratio may involve increasing a resistance of the neutral path (R_{Neutral Path}), which is comprised of the neutral bus bar 30, the ground wires 36 and the neutral lead 22. This can be accomplished by moving at least some of the ground wires 36 (the wires attaching to the neutral bus bar 30 from loads in the circuit) as far away as necessary from the knuckle 131 where the neutral lead 22 attaches to the neutral bus bar 30. This may increase the resistance of the parallel path 126 (R_{Neutral Path}) sufficiently and cause at least the minimum activation current to flow through the VCG 100. Alternatively, the ground wires 36 (the leads attaching to the neutral bus bar 30 from loads in the circuit) can be arranged so that the VCG lead wires 112, 114 may be made as short as possible and reduce the VCG resistance (R_{VCG1 Path}) (similar to the first method previously mentioned). Another alternative includes moving the ground wires 36 so that the length of the path through the neutral bus bar 30 is increased, thereby increasing the resistance along the parallel path 126 (R_{Neutral Path}) causing current to flow through the VCG 100. In yet another alternative, moving ground wires 36 (the leads attaching to the neutral bus bar 30 from loads in the circuit) to an area of the neutral bus bar 30 that has a reduced cross sectional area can also increase the resistance (R_{Neutral Path}) in the parallel path 126, thereby increasing the resistance along the parallel path 126 causing current to flow through the VCG 100. In still another alternative, at least some of the ground wires 36 may be arranged between the connection point of the first lead of the VCG 100 and the connection point of the second lead of the VCG 100. The number of ground wires 36 arranged between the two connection points may vary until the resistance ratio is achieved that causes at least the minimum activation current to flow through the VCG 100.

A third method of adjusting the resistance ratio may be to add an additional neutral bus bar 30 to the network or circuit. An additional neutral bus bar (not shown) may be added to increase an overall resistance of the neutral bus bar thus establishing a resistance ratio ((R_{Neutral Path})/(R_{Neutral Path}+R_{VCG Path})) that causes the minimum activation current to flow through the VCG 100.

The three methods discussed above may be used individually or in combination to establish the resistance ratio that causes the minimum activation current to flow through the VCG 100. Other methods may exist and will be known by the skilled artisan. In fact, any method that either reduces the resistance of the VCG 100, or increases the resistance of the neutral bus bar 30, or reduces the resistance of the VCG 100 and increases the resistance of the neutral bus bar 30 may be used to establish the resistance ratio that causes the minimum activation current to flow through the VCG 100.

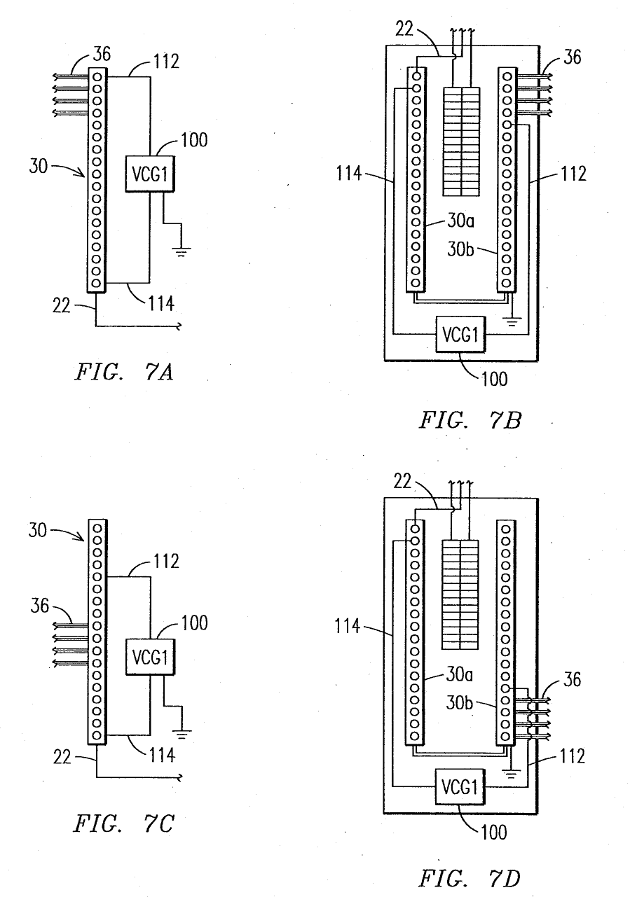

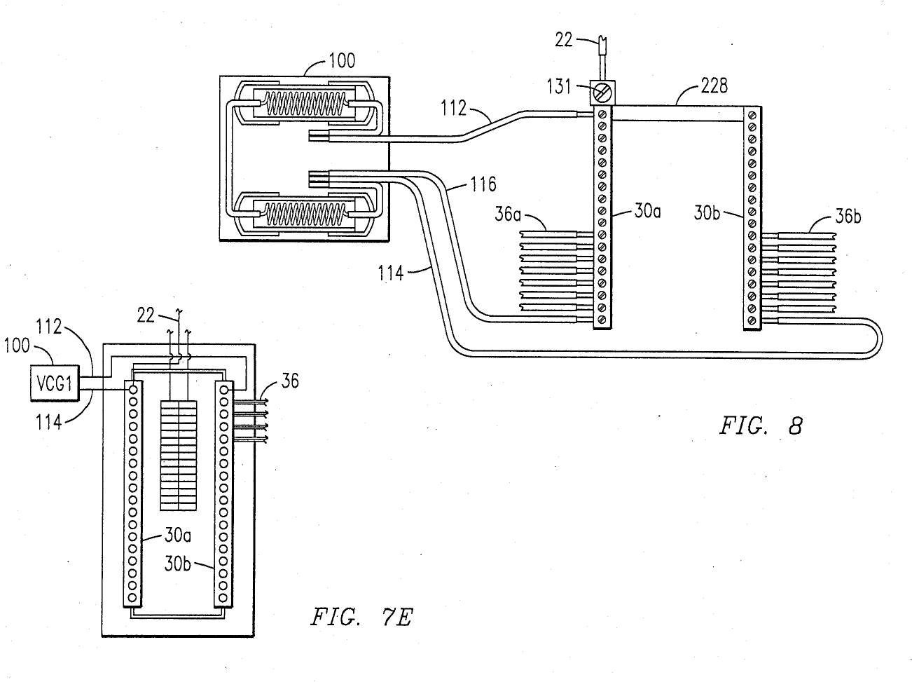

Turning now to FIGS. 7A-7E, alternate installation configurations are presented. Each of the installation configurations shares in common the concept that the leads of the VCG 100 are attached to the neutral bus bar 30 such that at least some of the ground wires 36 (the leads returning from electrical circuits throughout the electrical network of the facility, e.g. the electrical sockets) are arranged between the leads 112, 114 of the VCG and one of the VCG leads is connected at the knuckle 131 of the neutral bus bar 30. FIG. 7A illustrates an installation configuration showing the VCG 100 installed with one lead 114 connected to the neutral bus bar 30 as close as possible to the neutral lead 22 and the other lead 112 connected to the neutral bus 30 beyond the ground wires 36, which also connect to the neutral bus bar 30. FIG. 7B illustrates an installation configuration having two neutral bus bars 30a, 30b. The VCG 100 is installed with one lead 114 connected to the (left) neutral bus bar 30a as close as possible to the neutral lead 22, which is attached to the (left) neutral bus bar 30a, and the other lead 112 connected to the (right) neutral bus bar 30b at a location past the ground wires 36 such that a portion of the “noisy” current supplied by the ground wires 36 is able to flow through the VCG 100. Since there is current on the neutral bus bar 30, current can flow through the VCG 100. FIG. 7C illustrates an installation configuration showing the VCG 100 installed with one lead 114 connected to the neutral bus bar 30 as close as possible to the neutral lead 22 and the other lead 112 connected to the neutral bus bar 30 beyond the ground wires 36, which also connect to the neutral bus bar 30. FIG. 7D illustrates another installation configuration having two neutral bus bars 30a, 30b. The VCG 100 is installed with one lead 114 connected to the (left) neutral bus bar 30a as close as possible to the neutral lead 22 and the other lead 112 connected to the (right) neutral bus bar 30b and in relation to the ground wires 36 such that a portion of the “noisy” current supplied by the ground wires 36 is able to flow through the VCG 100. FIG. 7E illustrates yet another installation configuration having two neutral bus bars 30a, 30b. The VCG 100 is installed with one lead 112 connected to the (left) neutral bus bar 30a as close as possible to the neutral lead 22 and the other lead 114 connected to the (right) neutral bus bar 30b and in relation to the ground wires 36 such that a portion of the “noisy” current supplied by the ground wires is able to flow through the VCG 100.

FIG. 8 shows an alternate embodiment for installing a VCG 100 having a first lead 112, a second lead 114, and a third lead 116. As with previous installations, one of the leads, and in this illustration, the first lead 112, is attached to the neutral bus bar 30 as close as necessary to the knuckle 131 of the neutral bus bar 30. Illustrated is a configuration having two neutral bus bars 30a, 30b, with each bus bar having respective ground wires 36a, 36b attached thereto. Since there are two neutral bus bars 30a, 30b and each neutral bus bar has respective ground wires, the second lead 114 and the third lead 116 are beneficial for capturing more of the “noisy” current and flowing the “noisy” current through the VCG 100. A joining strap 228 is also provided and provides a path for current to flow between the neutral bus bars 126a, 126b.

The following is an example of one method of installation of the VCG 100 according to the embodiments of the present disclosure. The VCG 100, in this example installation, is a VCG 100 having an internal resistance in the range of 15 to 30 milli-ohms and an internal inductance in the range of 3 to 6 micro-henries. The combined resistance and inductance of the VCG 100 influence an impedance of the VCG 100.

Referring to FIG. 6, a method of installation of the VCG 100 is described. For this exemplary discussion, it is assumed that the minimum activation ratio for the VCG 100 has been determined either by experiment or analysis. A front panel cover (not shown) may be removed from a circuit breaker box (not shown) by an installer. A ground wire 104 of the VCG 100 is attached to a circuit breaker box safety ground bar (not shown). A neutral bus bar 30 has a plurality of ground wires 36 connected to it, and in this example, the ground wires 36 are grouped near one end of the neutral bus bar 30. The total current (I_{T}) on the neutral lead must be measured and the minimum activation current may be calculated. A device, such as an amp-meter, for example, capable of measuring current/volts/amps may be required to measure the current. One of the two leads 112, 114, for example 114, of the VCG 100 is attached as close as possible to a neutral lead 22, preferably at a knuckle 131, which is attached to one end of a neutral bus bar 30. The remaining lead, for example 112, is attached near the other end of the neutral bus bar 30. The VCG 100 is now installed and the current flowing through the VCG, I_{VCG}, must be measured. An amp-meter, for example, may be used to measure the current flowing through the VCG 100. A current of preferably at least 3 milliamps per amp of the total current (I_{T}) measured on the neutral lead 22, and more preferably at least 5 milliamps per amp of the total current (I_{T}) previously measured on the neutral lead 22 should be flowing through the VCG 100. If a current of at least 3 milliamps per amp of the total current (I_{T}) previously measured on the neutral lead 22 is not flowing through the VCG 100, at least one of the following steps, or a combination of the following steps, can be performed to increase or decrease the resistance of the VCG 100 or neutral bus bar 30 so the desired current of at least 3 milliamps per amp of the total current (I_{T}) previously measured on the neutral lead 22 is flowing through the VCG 100. The steps are intended in increase or decrease the resistance of the VCG 100 or the neutral bus bar 30. By decreasing the resistance of the VCG 100 and/or increasing the resistance of the neutral bus bar 30, the current flowing through the VCG 100 can be adjusted so at least the minimum activation current is flowing through the VCG 100. The steps at least include:
1. The resistance of the VCG 100 can be reduced by reducing the length of the VCG lead wires 112, 114 to reduce the resistance and change the impedance of the VCG 100;
2. The resistance of the neutral bus bar 30 can be increased by moving the ground wires 36 as far away as necessary from the neutral lead 22;
3. The ground wires 36 can be arranged so the VCG lead wires 112, 114 may be made as short as possible;
4. The ground wires 36 can be rearranged along the neutral bus bar 30 to increase the resistance of the neutral bus bar 30; or
5. The ground wires 36 can be moved to an area of the neutral bus bar 30 having a reduced cross sectional area. This will increase the resistance in the neutral bus bar 30.

Therefore, for this example installation, if the VCG 100 is installed and the installer measures less than 3 milliamps per amp of the total current (I_{T}) measured on the neutral lead 22 prior to installation of the VCG 100 flowing through the VCG 100, the installer can, for example, reduce the length of VCG leads 112, 114, thereby reducing the overall resistance of the VCG, to increase the current flow through the VCG 100. The installer can, as another example, move the ground wires 36 to a different location on the neutral bus bar 30 to increase the resistance of the neutral bus bar 30 and increase the resistance ratio to cause more current to flow through the VCG 100.

The disclosure has been described herein in terms of preferred embodiments and methodologies considered to represent the best mode to date of carrying out the disclosure. While at least one exemplary embodiment has been presented in the foregoing detailed description of the disclosure, it should be appreciated that a vast number of variations exist. In fact, a wide variety of additions, deletions, and modifications might well be made to the illustrated embodiments without departing from the spirit and scope of the invention as set forth in the claims. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure, it being understood that various changes may be made in the function and arrangement of elements described in an exemplary embodiment without departing from the scope of the disclosure.

We claim:

1. In a passive electrical circuit having a first electrical element enclosed within a non-conductive structure and surrounded by a ferrous material, a second electrical element enclosed within a non-conductive structure and connected in series to said first electrical element, arranged proximate to said second electrical element, and a conductive enclosure surrounding said first electrical element and said second electrical element, the first electrical element having a first lead and the second electrical element having a second lead, the first and second leads extending from said conductive enclosure and attached to a current carrying neutral bus bar, the improvement thereto comprising the first lead electrically connected to said neutral bus bar and electrically connecting said second lead said neutral bus bar such that a total current on said current carrying neutral bus bar is divided with a first current flowing through said passive electrical device and a second current flowing through said current carrying neutral bus bar, such that said first current is at least equal in magnitude to a minimum activation current for said passive electrical device.

2. The device of claim 1, wherein said minimum activation current is at least 0.3 percent of said total current.

3. The device of claim 2, wherein said minimum activation current at least 0.5 percent of said total current.

4. The device of claim 2, wherein said first electrical element and said second electrical element are solenoids.

5. The device of claim 4, wherein each solenoid is formed from a wire having between 12 and 14 turns.

6. The device of claim 1, wherein said passive electrical device has a device resistance and said current carrying neutral bus bar has a bus bar resistance.

7. The device of claim 6, wherein a ratio of said device resistance to said bus bar resistance is such that the minimum activation current flows through the passive electrical device.

8. The device of claim 1, further comprising a feedback loop within said passive electrical device that adjusts a device resistance to cause at least said minimum activation current to flow through said passive electrical device.

9. The device of claim 1, wherein said ferrous material is a plurality of iron shads.

10. The device of claim 2, wherein said first electrical element and said second electrical element are toroidal coils arranged adjacent each other on a common magnetic core.

11. The device of claim 1, wherein said neutral bus bar is a neutral bus bar in a circuit breaker box of a residential dwelling or a circuit breaker box of a commercial facility.

12. The device of claim 1, wherein a plurality of neutral leads are electrically connected to said neutral bus between a neutral main near a first end of said neutral bus bar and a second end of said neutral bus bar, wherein one of said first lead or said second lead is electrically connected to said neutral main and the other of said first lead or said second lead is electrically connected to said neutral bus bar such that at least one neutral lead of said plurality of neutral leads are electrically connected between said first lead and said second lead.

13. A method of reducing a consumption of electrical power in an electrical network, comprising the steps of:
(a) determining a minimum activation ratio of an electrical component for use in an electrical circuit, the electrical circuit comprising a current carrying neutral main attached to a neutral bus bar;
(b) measuring the current at the neutral lead flowing on the current carrying neutral bus bar;
(c) connecting the electrical component to the neutral bus bar to establish a parallel electrical connection between the electrical component and a portion of the neutral bus bar so the current is divided into a bus bar portion current and an electrical component current; and
(d) adjusting said electrical connection so at least a minimum activation current flows through said electrical component.

14. The method of claim 13, further comprising the step of measuring said electrical device current after said electrical device is electrically connected to said current carrying neutral bus bar.

15. The method of claim 13, wherein said electrical component further comprises a first electrical lead and a second electrical lead, said first electrical lead being electrically connected to said neutral bus bar at a first connection location and said second electrical lead being connected to said neutral bus bar at a second connection location.

16. The method of claim 15, wherein said first connection location is a neutral main.

17. The method of claim 15, wherein said electrical connection is adjusted by reducing a length of said first electrical lead of said electrical component.

18. The method of claim 15, wherein said electrical connection is adjusted by reducing a length of said second electrical lead of said electrical component.

19. The method of claim 17, wherein said electrical connection is adjusted by reducing a length of said second electrical lead of said electrical component.

20. The method of claim 15, wherein said electrical connection is adjusted by changing said connection location of said second electrical lead.

21. The method of claim 20, wherein said electrical connection is further adjusted by reducing a length of said first electrical lead of said electrical component.

22. The method of claim 20, wherein said electrical connection is further adjusted by reducing a length of said second electrical lead of said electrical component.

23. The method of claim 21, wherein said electrical connection is further adjusted by reducing a length of said second electrical lead of said electrical component.

24. The method of claim 13, wherein said electrical device is a passive electrical device.

25. The method of claim 13, wherein said minimum activation ratio is at least 0.003 amperes per ampere of said current flowing on said current carrying neutral bus bar.

26. The method of claim 13, wherein said minimum activation ratio is at least 0.005 amperes per ampere of said current flowing on said current carrying neutral bus bar.

27. The method of claim 13, wherein said minimum activation current is at least 0.3 percent of said current.

28. The method of claim 27, wherein said minimum activation current is at least 0.5 percent of said current.

29. The method of claim 13, wherein said minimum activation current is said electrical device current.

30. The method of claim 13, further comprising a second current carrying neutral bus bar.

31. The method of claim 13, wherein a plurality of neutral leads are connected to said current carrying neutral bus bar.

32. The method of claim 31, wherein said neutral leads are grouped such that the minimum activation current flows through said electrical device.

33. In combination:
a circuit breaker assembly;
a neutral bus bar;
a plurality of ground wires connected to said neutral bus bar from a plurality of power consuming equipment;
a first and second electrical conductor connected across an alternating power source and a third electrical conductor that is a neutral conductor connected to said neutral bus bar, said first second and third electrical conductors externally entering said circuit breaker assembly, wherein said first and second conductors provide a quantity of power for an electrical load external to said circuit breaker box; and
an electrical component having a component resistance and having first and second leads connected to said neutral bus bar placing said electrical component in parallel connection with said neutral bus bar, the resistance of said electrical component, including said leads, and resistance of said neutral bus bar being balanced to effect at least a prescribed minimum activation ratio between current flowing through said electrical component and current flowing through said neutral conductor.
